(19) United States
(12) Patent Application Publication
(10) Pub. No.: US 2023/0329253 A1
(43) Pub. Date: Oct. 19, 2023

(54) Reusable Cooking Truss System For Poultry

(71) Applicant: John Kaufman, Murphy, NC (US)

(72) Inventor: John Kaufman, Murphy, NC (US)

(21) Appl. No.: 18/121,257

(22) Filed: Mar. 14, 2023

Related U.S. Application Data
(60) Provisional application No. 63/320,358, filed on Mar. 16, 2022.

(51) Int. Cl. A22C 21/00

(52) U.S. Cl. CPC A22C 21/0038

(57) ABSTRACT

A reusable cooking truss system for poultry. The truss system has a limited number of teeth so as to not puncture or interfere with the cooking process while also still being able to secure varying sizes of birds. The straps which are used may also come in varying sizes for the different parts of the poultry.

### CROSS-REFERENCE TO RELATED APPLICATIONS

This application relates back to US 63/320,358 filed on Mar. 16, 2022 and incorporates that application in its entirety.

### BACKGROUND OF THE INVENTION

Cooking poultry evenly has typically been accomplished by tying the bird’s thighs and wings in a certain orientation to help facilitate even cooking. However, the tying process is burdensome, and the string isn’t reusable.

Rotisserie chicken and other meats often require tying the meat and its bones with string. Meat that is not secure enough with the string can cause skipping and result in improper cooking or damage to the meat. Dealing with messy and greasy hands trying to handle meat can be frustrating and require several hand washings while preparing foods.

### SUMMARY OF THE INVENTION

The present subject matter is a truss system that uses plastic straps with teeth to secure the poultry in the proper orientation for cooking. The plastic straps come in varying sizes for the different portions of the bird and provide users with a lockable tying mechanism for rotisserie meats and other roasted foods.

The present subject matter allows users to hold meats and bones in place with ease, replacing time-consuming and frustrating cooking strings and toothpicks. The present subject matter includes a locking tab and multiple teeth along the length of the device, allowing users to snap the mechanism in place and firmly secure the meat.

The present subject matter features a locking system to lock in the length needed for tying off meats and other roasted food items. The device is also both washable and reusable, replacing cooking string and toothpicks. Users can apply the zip tie-like item around the desired area of a food item and lock it into place via a limited number of small teeth along its length. The snap mechanism locks the teeth in place at an adjustable length.

The strap meant for the legs of five-to-eight-pound bird is generally 5-6 inches long. The strap for the wings and thighs is generally 20-22 inches long. Straps of varying lengths may be used to accommodate particularly large or small birds.

The present subject matter has a limited number of teeth as to not puncture or interfere with the cooking process while also still being able to secure varying sizes of birds.

In some embodiments, there is a loop similar to that used for a belt in pants, such that an extra strap can slide around and that it can hold the extra strap, no matter the length.

What has been described herein includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible.

Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### BRIEF DESCRIPTION OF DRAWINGS

FIG. 1 shows a perspective side view of the straps of varying lengths which can accommodate different sized poultry.

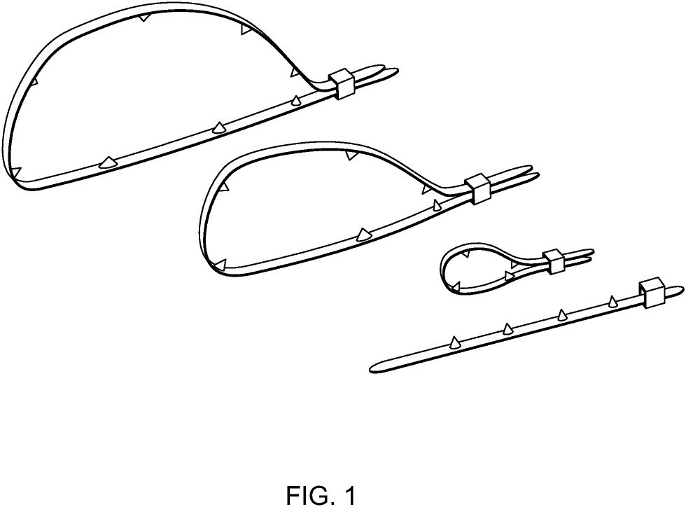

FIG. 2 shows a perspective side view of the chicken being trussed so as to facilitate even cooking.

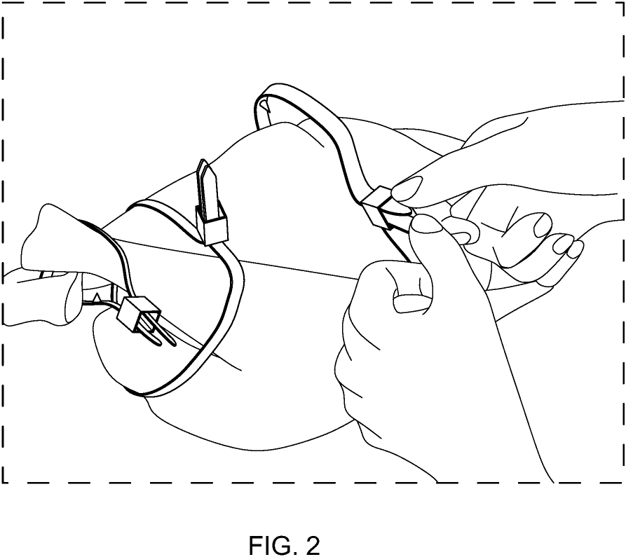

1. A reusable cooking truss system for poultry comprising of a plurality of straps with limited teeth.

2. The reusable cooking truss system for poultry comprising of a plurality of straps with limited teeth as in claim 1, wherein the plurality of teeth a limited as to not puncture or interfere with the cooking process while also still being able to secure varying sizes of birds.

3. The reusable cooking truss system for poultry comprising of a plurality of straps with limited teeth as in claim 1, wherein the strap for the wings and thighs is 20-22 inches long.

4. The reusable cooking truss system for poultry comprising of a plurality of straps with limited teeth as in claim 1, wherein the strap for the legs of five-to-eight-pound bird is 5-6 inches long.

5. A method of using reusable cooking truss system for poultry comprising of a plurality of straps with limited teeth.

6. The method of using reusable cooking truss system for poultry comprising of a plurality of straps with limited teeth as in claim 5, wherein the plurality of teeth a limited as to not puncture or interfere with the cooking process while also still being able to secure varying sizes of birds.

7. The method of using reusable cooking truss system for poultry comprising of a plurality of straps with limited teeth as in claim 5, wherein the strap for the wings and thighs is 20-22 inches long.

8. The method of using reusable cooking truss system for poultry comprising of a plurality of straps with limited teeth as in claim 5, wherein the strap for the legs of five-to-eight-pound bird is 5-6 inches long.
